(19) United States
(12) Patent Application Publication
(10) Pub. No.: US 2003/0107139 A1
(43) Pub. Date: Jun. 12, 2003

(54) Scent delivery system

(76) Inventor: Gregory Drew Wohrle, Hollywood, FL (US)

Correspondence Address: Greg Wohrle, 1110 Cherrypalm Lane, Hollywood, FL, 33019, US

(21) Appl. No.: 10/217,216

(22) Filed: Aug. 12, 2002

Related U.S. Application Data
(63) Continuation-in-part of application No. 10/176,129, filed on Jun. 20, 2002.
Application No. 10/176,129 is a continuation-in-part of application No. 09/902,307, filed on Jul. 10, 2001.
(60) Provisional application No. 60/217,161, filed on Jul. 10, 2000.

(51) Int. Cl. B01D 47/00

(52) U.S. Cl. 261/142

(57) ABSTRACT

A scent-emitting system includes a plurality of cartridges containing scented fluids and seated within pockets formed in a system tray. A heating member is provided for heating the cartridges to encourage the formation of scented vapors and an actuation subassembly is provided for selectively actuating the scent cartridges to release the scented vapors. An internal fan generates an air flow for communicating the scented vapors through housing vent openings to an external environment.

### CROSS REFERENCE TO RELATED APPLICATION

This application is a continuation-in-part of co-pending application Ser. No. 10/176,129 filed on Jun. 20, 2002, which is a continuation-in-part of co-pending application Ser. No. 09/902,307 filed on Jul. 10, 2001, which claims the priority of provisional Application No. 60/217,161 filed on Jul. 10, 2000, now abandoned.

### BACKGROUND OF THE INVENTION

1. Field of the Invention

The present invention relates generally to scent emitting devices, and more particularly to an electronic scent diffusing system.

2. Description of the Prior Art

It is well known to use deodorizers, air fresheners, candles, plug-ins and the like, to provide a desired scent or aroma in a home, office or other such environment. In fact, many people place air fresheners in rooms to conceal existing undesirable odors, or merely to make the air more fragrant. Various types of air freshening devices are commercially available. Most such commercial air freshening devices provide for a predetermined single scent, and little or no means for controlling the strength, duration, coverage area and other characteristics of the emitted scent, as well as lack the ability to conveniently switch among different scents.

Some air fresheners that allow a user to selectively alter the scent delivered by a device have been described. For example, U.S. Pat. No. 5,695,692 to Kennedy and U.S. Pat. No. 5,178,327 to Palamand disclose air freshening units including a container which carries a cartridge having a plurality of segments, or sections, each having a solid material impregnated with a scented substance. In each case, the cartridge can be manually rotated to position a particular segment having a desired scent into alignment with an opening in the container to facilitate emission of the desired scent into the surrounding environment.

U.S. Pat. No. 2,103,609 to Bradburn discloses an air freshener having a body carrying a plurality of open-topped vials of scented substances. A rotatable cover is mounted on the body to close and seal the vials. The cover has an opening that can be selectively aligned with any one of the vials in order to enable the substance contained within the vial to evaporate into the air.

The aforementioned air fresheners share a number of disadvantages and limitations. For instance, each of the disclosed air fresheners must be manually manipulated to alter the type of scent and do not provide a convenient and user friendly way to switch among different scents. Additionally, all of the disclosed air fresheners provide little or no means for controlling the strength, duration and coverage area of the emitted scent. Furthermore, the disclosed air fresheners are provided in containers that would be unsightly positioned, for example, in a high-end home entertainment unit or even as a high-end decorative piece.

Electronic aroma generating devices and systems providing for more controlled scent emission have been described. For example, U.S. Pat. No. 5,591,409 to Watkins discloses an apparatus for introducing precisely controlled amounts of aromatic chemicals, using metered spray technology, into the immediate vicinity of the operator. The disclosed mechanism is particularly oriented toward use by an individual sitting at a desk using a microcomputer. Similarly, U.S. Pat. No. 5,724,256 to Lee et al. discloses a computer controlled odor mixing and dispensing system suitable for use in conjunction with a multimedia computer application. Neither of these systems are designed for, or suitable for, providing an aroma to a larger area such as one or more rooms of a home or office. Furthermore, they are not adapted for delivering an aroma from scented oils.

U.S. Pat. No. 4,603,030 to McCarthy, U.S. Pat. No. 5,832,320 to Wittek, and U.S. Pat. No. 5,972,290 to De Sousa each describe scent-emitting systems designed to provide a variety of scents to intensify sensorial perception of an audience in attendance of a visual and/or acoustical representation, by introducing scents in synchronism with the visual and/or acoustic representation. However, the aforementioned systems are complex, expensive and adapted for emitting scents over a very large area such as a movie theater.

Accordingly, there is an existing need for a scent emitting system particularly suited for use in a home, workplace, or like environment that overcomes the aforementioned disadvantages and limitations of the aforementioned prior art systems.

### SUMMARY OF THE INVENTION

The present invention provides an electric/electronic scent-emitting system configured for selectively delivering predetermined scents generated by scented oils contained within scent cartridges to a proximate surrounding environment.

In this aspect of the present invention, an electronic, electro-mechanically actuated, multi-cartridge scent-delivery system is provided. A system housing defines a tray-receiving opening extending into an interior space and configured for supporting a tray within the interior space and movable between open and closed positions. A plurality of cartridges each containing selected scented fluids are seated within pockets located around a rotating carousel on top of the tray. Mechanical means is provided for rotating the carousel to a fixed location corresponding with the positioning of a specific cartridge. An electromechanical actuation member situated over the chosen cartridge selectively actuates the cartridge between a closed position and an open scent-emitting position by vertical displacement of the actuating member. Housing vents are provided for communicating a scent from the interior space to the exterior environment. Preferably, a blowing means is provided for creating and subsequently directing a flow of air over the scent cartridges for egress through the housing vents. Preferably, heating means are provided for heating the scented fluids contained within the cartridges to increase the strength of the emitted scents. Preferably, a fan-speed control mechanism is provided for varying the scent coverage area, and a timer is preferably provided for controlling the duration of the scent emission and/or presetting a time of operation. Furthermore, a printed circuit board/micro-processor is preferably provided for remote control operation, advanced programming of operation, and an LCD display.

These and other aspects, features, and advantages of the present invention will become more readily apparent from the attached drawings and the detailed description of this aspect of the present invention, which follow.

### BRIEF DESCRIPTION OF THE DRAWINGS

This aspect of the present invention will hereinafter be described in conjunction with the appended drawings provided to illustrate and not to limit the invention, where like designations denote like elements, and in which:

FIG. 1 is a perspective view of an electronic, electro-mechanically actuated, multi cartridge scent-delivery system in accordance with a preferred aspect of the present invention, wherein the scent cartridge-supporting tray is depicted in a closed position;

FIG. 2 is a perspective view of the multi-cartridge scent delivery system of FIG. 1, wherein the scent cartridge-supporting tray is depicted in an open position;

FIG. 3 is a perspective view of the multi-cartridge scent delivery system of FIG. 1 with part of the top and right sides of the housing removed to expose the interior of the system;

FIG. 4A is a close up sectional view, shown on FIG. 3, of the cartridge and its relationship with the cartridge actuator, the metal tub, the carousel, and the heater in the displaced cartridge and metal tub version;

FIG. 4B is a close up sectional view, shown on FIG. 3., of the cartridge and its relationship with the cartridge actuator, the metal tub, the carousel, and the heater in the displaced heating element version;

### DETAILED DESCRIPTION OF THE INVENTION

Shown throughout the figures, this aspect of the present invention is generally directed to an electronic portable multi-scent delivery system for use in homes, offices and the like. The system includes a scent-delivery unit configured for actuating specially configured scent cartridges by electromechanical means. Significantly, the system design facilitates the installation and/or removal of the scent cartridges, and the process of switching among them, enabling an end user to efficiently and conveniently select a desired scent or aroma. In addition to facilitating scent selection, the system incorporates means for enabling end user control over the strength of the emitted scent, the coverage area of the emitted scent, and the duration of scent emission, as well as allows for remote control operation and advanced programming functions.

The Scent Cartridge

This invention is adapted for use with a scent-emitting cartridge having a unique construction. The cartridge structure has been previously described in co-pending application Ser. No. 09/902,307, filed by the same inventor on Jul. 10, 2001, and incorporated herein by reference. However, the following description of the cartridge is provided in an effort to facilitate an understanding of the cartridge as incorporated into this aspect of the present invention described herein.

Referring briefly to FIG. 6, scent cartridge assembly 100 includes a lower housing body 102 and an upper housing cap 124 separated by a sealing gasket member 109 interposed between respective abutting edges 107 and 123. The lower housing body 102 and upper housing cap 124 are preferably molded from a polymer having a melting temperature (Tₘ) sufficiently high to prevent melting of the housing from cartridge heating during system operation. The housing can be constructed from either transparent or opaque polymers. In some instances, a transparent housing may be preferred to enable a system operator to periodically inspect a cartridge scent oil level to determine whether cartridge replacement is necessary.

Lower housing body 102 includes an integral upwardly extending walled body 104 defining a channel 106. A T-shaped member, shown generally as reference numeral 110, includes a base 114 having an integral body 112 depending downwardly therefrom. The outer surface of body 112 is sized and shaped for enabling body 112 to be snugly received within channel 106. Compression spring 108, or an alternate compression member, is received within channel 106 of walled body 104. Preferably, the upper end of compression spring 108 does not extend beyond the upper end of body 104 in its non-compressed equilibrium state. T-member body 112 is received within channel 106 such that it remains supported by the upper end of compression member 108. In this manner, when body 112 is received within channel 106, the spring 108 acts to bias T-shaped member 110 in an upward direction.

Base 114 of T-member 110 is provided having a raised upper surface portion 116 defining a peripheral ledge 118. Furthermore, raised surface portion 116 has a centrally positioned nub 119 protruding upwardly therefrom. Nub 119 is sized, shaped and oriented to extend through aperture 128 in housing cover 124 when the cartridge is fully assembled. Gasket member 120 is provided having a continuous interior peripheral groove 121 sized and shaped for being sealingly fitted about ledge 118 of T-shaped member 110.

In addition to nub receiving aperture 128, upper housing cap 124 includes a plurality of apertures 126 for enabling the passage or communication of scents from the cartridge interior.

Lower housing body 102 is filled with a volume of scented oil (not shown), preferably to a level at least slightly below the upper end 107 of lower housing body 102. When the cartridge is fully assembled, the cartridge compression spring 108 biases T-shaped member 110 upwardly such that gasket 120 forms a substantially air tight seal against the inner surface of housing cap 124. In this manner, the gasket prevents the emission of any scent or aroma emanating from the scented oil in housing base 102 through the housing cover apertures 126, 128. Cartridge 100 can be actuated into an open position by providing a downward force against nub 119. In particular, downward actuation of nub 119 causes corresponding downward displacement of T-member 110, thereby breaking the seal formed around the cartridge apertures 126, 128 to enable the emission of scented fumes there through.

Throughout the specification, reference is made to the actuation of the scent cartridge into an open position by the force of an actuating structure or member against nub 119. As previously described, nub 119 is an integral structure formed upon the upper surface of T-member 110. As will be apparent to those skilled in the art, nub 119 is merely provided as a convenient contact point for applying a downward force against T-member 110. Consequently, T-member 110 could just as easily be formed without nub 119. In that case, the force of a particular actuating structure could be applied directly to the upper surface of T-member 110. Accordingly, any reference herein to the actuation of nub 119, making contact with nub 119, etc. are not intended to be limiting. That is, actuating nub 119 is intended to be equivalent to actuating T-member 119.

The Scent Delivery System

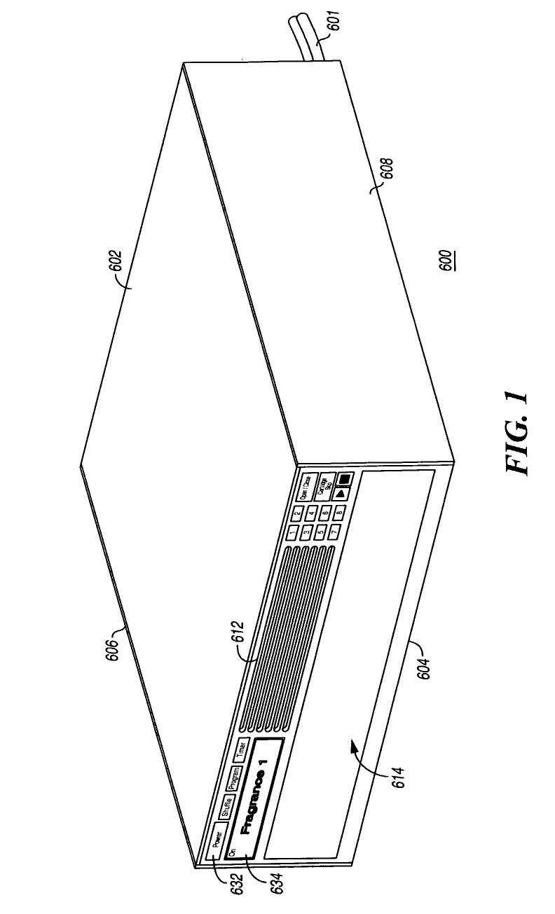

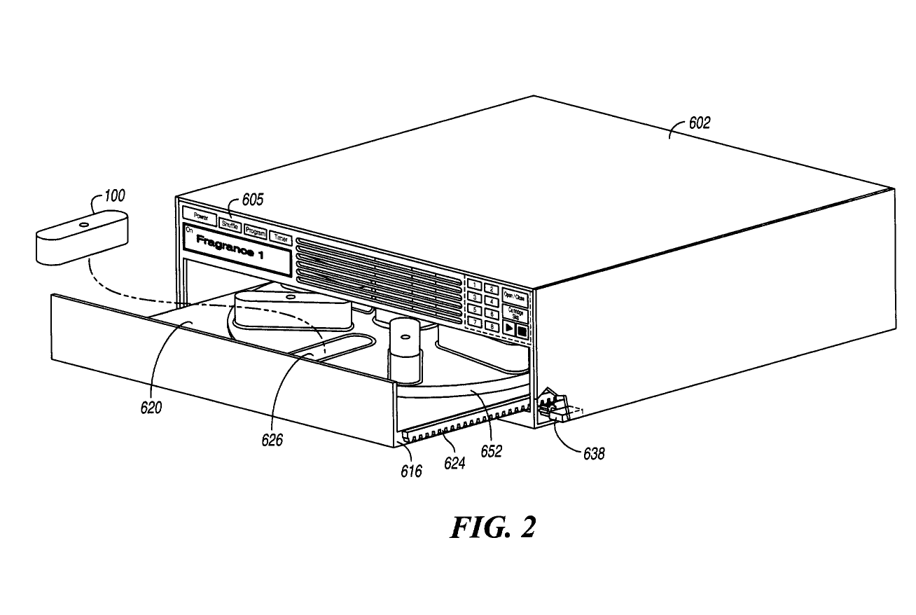

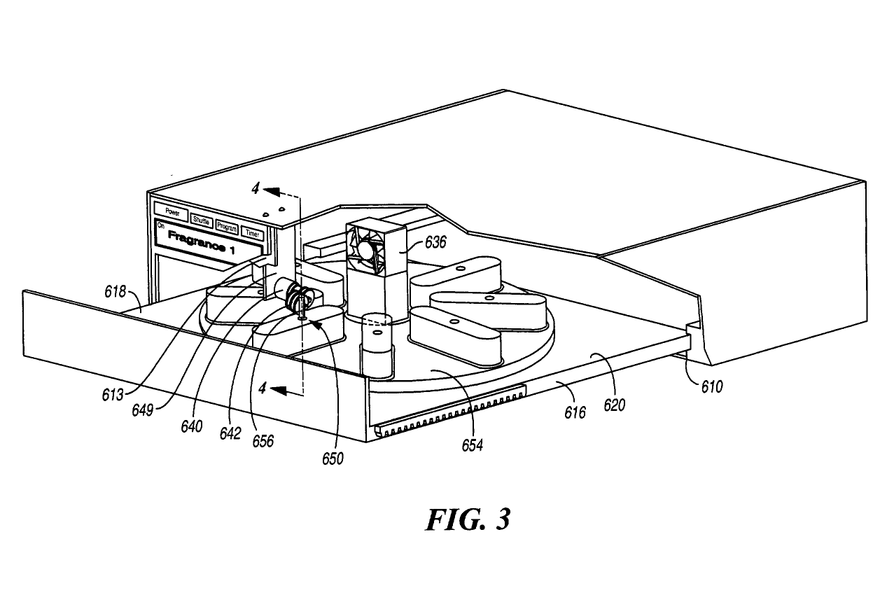

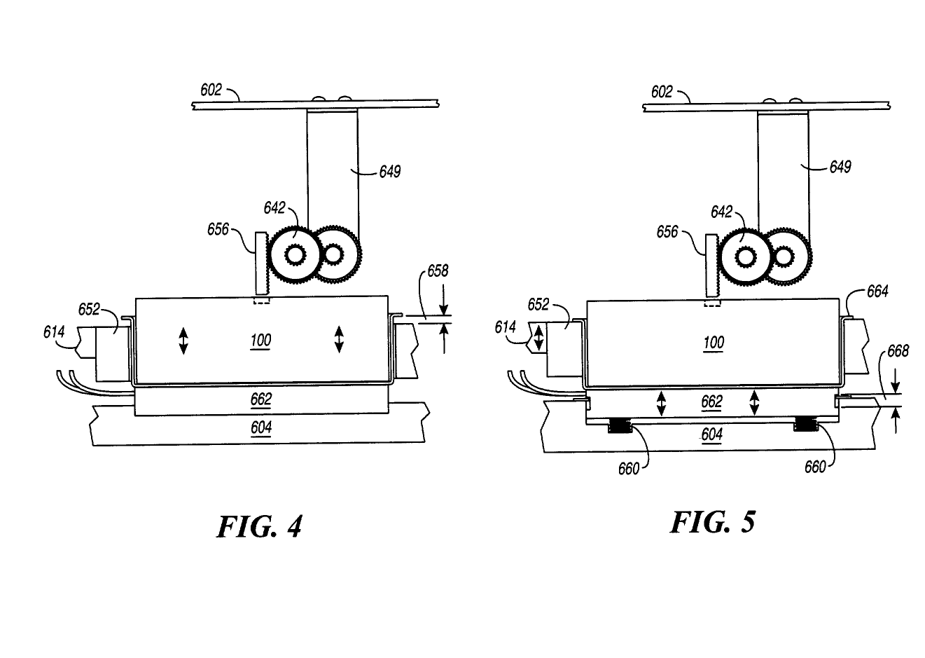

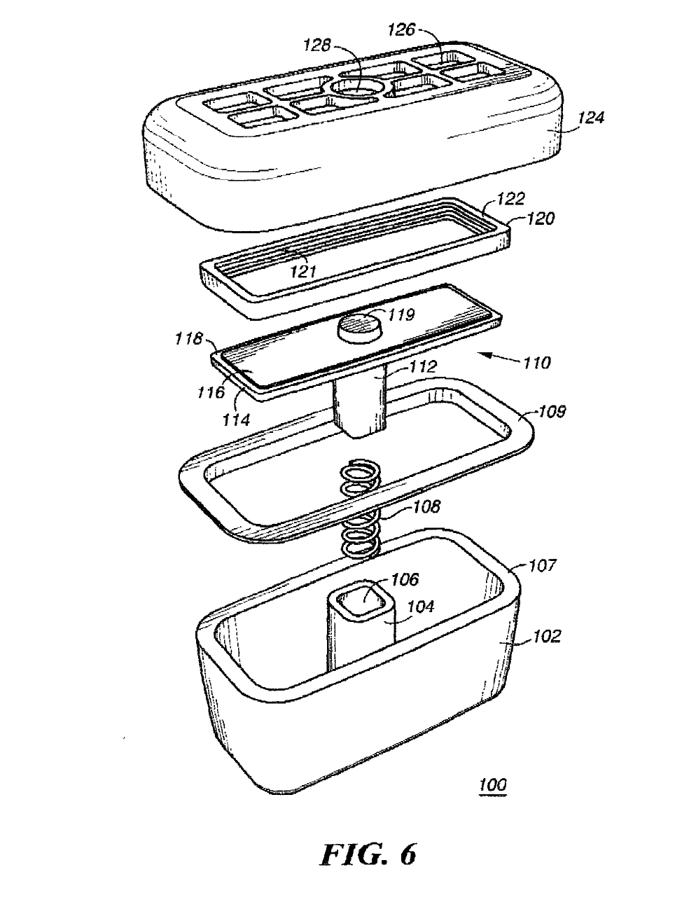

Referring now to FIGS. 1-5, an electronic, electro-mechanically actuated, multi-cartridge scent delivery system, shown generally as reference numeral 600, is illustrated as a preferred aspect of the present invention. The main components of the system are contained within a housing structure generally defined by top 602, bottom 604, left side 606, right side 608, front face portion 605, and front face portion 622 of tray 614. Front face portion 605 is provided having integral vent openings 612 through which scents are emitted from the interior of the housing to a proximate external environment. As further described below, function buttons 632 are provided extending through front face portion 605 for controlling the operation of the system. Visual display means, such as a Liquid Crystalline Display {LCD) 634 is preferably provided for communicating current settings during operation.

System tray 614 is supported at its sides 616 and 618 by interior housing supporting rails 610. Motorized pinions 638 mounted to the interior-housing surface cooperate with racks 624 running along the sides 616 and 618 of the tray 614 to effect forward and rearward tray movement. In this manner, the tray can be automatically opened and closed via one of the external control buttons 632 electrically coupled to the pinion mechanism. A rotating carousel 652 is located on top of tray 614 on upper surface 620. Rotating carousel 652 extends down through upper surface 620 of tray 614. Pockets 626 formed in rotating carousel surface 654 are sized and shaped for snugly receiving cartridges 100 therein and have an open bottom extending through tray 614 and rotating carousel 652. Preferably, each pocket 626 includes a shapely fitting heat diffusion member 664 set in the pocket. Heat diffusion member 664 is a slip fit metal tub that extends through the bottom of pocket 626 and supports cartridge 100.

Heating member 662 is provided for transferring heat to the scented fluid within cartridge 100, thereby increasing the strength of the emitted aroma. This is accomplished by heating member 662 making direct contact with heat diffusion member 664. Heating member 662 is located in housing bottom 604, directly under actuation position 650, the fixed location where carousel 652 rotates cartridge 100 to be actuated. Upon rotation of carousel 652, as cartridge 100 and corresponding pocket 626 move to the actuation position, corresponding slip-fit heat diffusion member 664 is displaced upwards, shown by 658, as it passes over heating element 662, thereby resting on top of and making direct contact with heating member 662. Alternatively, heat diffusion member 664 could be a fixed press fit metal tub, and heating member 662 could be set on compression springs 660, and upon rotation of carousel 652, as cartridge 100 and corresponding pocket 626 move to the actuation position, heating member 662 would be displaced downward, shown by 668, by passing over heat diffusion member 664, thereby having heating member 664 rest on top of and make direct contact with heating member 662.

The top surface 620 of tray 614 includes a fan 636 for directing a flow of air generated over the top sides of the cartridges and toward vent openings 612. Fan 636 is preferably mounted in the middle of rotating carousel 652. Preferably, the fan speed is variable to enable user control over the scent coverage area.

A motor 640 is provided secured to the interior surface of housing top 602 by a bracket 649. Motor 640 drives gear mechanism 642 that, in turn, engages vertically disposed actuating member 656 for upward and downward movement. Actuating member 656 is positioned directly above actuation position 650 and in turn, directly above cartridge nub 119 when tray 614 is in a closed position. Consequently, during downward movement member 656 engages T-member 110 to effect actuation of a specifically chosen cartridge 100 into an open, scent-emitting position.

As will be apparent to those skilled in the art, myriad of means could be employed for imparting a downward force against T-member 110 to effect actuation of cartridge 100 into an open scent-emitting position without departing from the intended scope of the invention. For example, a solenoid could be positioned directly over the actuation position and the specific T-member 110. Alternatively, a motor/gear box could be provided rotating a cam driving a vertically actuating member downward against T-member 110. Furthermore, a worm gear could be used to drive a cooperating actuating member downward against T-member 110.

Preferably, each scent-containing cartridge is associated with an individual control button on the front of the system housing such that a user can effect the emission of a desired scent by merely pressing the associated control button. In operation, upon pressing the button associated with the user-selected scent, carousel 652 rotates until the appropriate cartridge 100 moves into actuation position 650 to effect actuation of the corresponding cartridge nub 119 of the cartridge 100 containing the desired scent.

Additional control buttons are provided for controlling other system functions including, for example, system power, fan speed, cartridge heating temperature and carousel rotation. Preferably, printed circuit board/micro-processor 613 is concurrently used to control some more advanced electronic functions including remote control operation, LCD display control, random play, and shuffle, to name a few. Additionally, a timer can be provided for selecting the duration of emission of a particular scent and/or to pre-select a time of operation. Electrical power is provided to the system via power input means 601.

This system incorporates conventional commercially available electronic components and circuitry (not shown) for controlling the various electronic system functions described herein. The incorporation of electronics to enable such control is well known to those skilled in the art and further description is not provided.

Since many modifications, variations, and changes in detail can be made to this aspect of the present invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A scent-delivery system, comprising:
a housing defining an interior space and having at least one aperture for the communication of air from said interior space to the exterior environment;
an interior support structure within said housing;
a plurality of cartridges each containing a scented fluid and supported by said interior support structure;
electro-mechanical actuating means for actuating each of said plurality of said cartridges between a closed and open position;

2. A scent-delivery system as recited in claim 1, further comprising:
blowing means for creating an air flow directed toward said plurality of cartridges; and/or
heating means and heat diffusion means interposed between said heating means and said cartridge; and/or
timing means for controlling the duration of operation of the system and for pre-selecting a desired starting/stopping time of operation of the system.

3. A scent-delivery system as recited in claim 2, further comprising means for electronically controlling the function of said blowing means, said heating means and said timing means.

4. A scent-delivery system as recited in claim 3, wherein said housing has vent openings provided therein for facilitating the communication of a cartridge-emitted scent from the housing interior space to an exterior surrounding environment.

5. A scent-delivery system as recited in claim 4, wherein said blowing means further comprises a fan attached to said interior support structure and particularly oriented for directing an air flow over top sides of said cartridge and toward the vent openings.

6. A scent-delivery system as recited in claim 2, wherein said housing has a tray-receiving opening.

7. A scent-delivery system as recited in claim 6, wherein said interior cartridge supporting structure further comprises a tray supported within said housing and slidably movable through said tray-receiving opening between open and closed positions.

8. A scent-delivery system as recited in claim 7, where in said cartridge supporting tray further comprises:
an upper surface generally bounded by a left side, a right side, a rear side and a front face, said upper surface supporting a rotating carousel having a plurality of pockets sized and shaped for having said plurality of cartridges seated therein;

9. A scent delivery system as recited in claim 8, further comprising means for rotating the said carousel to a fixed location to effect the movement of said cartridges and to move a chosen cartridge into a fixed actuation position.

10. A scent-delivery system as recited in claim 9, wherein said heat diffusion means further comprises;
metal tubs permanently fitted at the base of said pockets, sized and shaped for having cartridges seated therein; and
said metal tubs positioned to make contact with said heating means when said cartridge and corresponding said metal tub rotates into said actuation position.

11. A scent-delivery system as recited in claim 10, where in said heating means further comprises;
a heating element; and
said heating element is situated on top of two compression springs and upon said rotation of said cartridge and corresponding said metal tub to said actuation position, said heating element is displaced downward by passing said cartridge and said permanently fitted metal tub.

12. A scent-delivery system as recited in claim 9, where in said heat diffusion means further comprises;
metal tubs slip fitted at the base of said pockets, sized and shaped for having cartridges seated therein;
said metal tubs positioned to make contact with said heating means when said cartridge and corresponding said metal tub rotates into said actuation position.

13. A scent-delivery system as recited in claim 12, wherein said heating means further comprises;
a heating element; and
said heating element permanently situated at the base of said actuation position and upon said rotation of said cartridge and corresponding said tub to said actuation position, said slip-fit tub and corresponding said cartridge is displaced upward as it passes over said heating element.

14. A scent-delivery system as recited in claim 9, wherein said electromechanical actuating means further comprises means for driving one or more actuating members downwardly against an upper surface of said scent cartridges.

15. A scent-delivery system as recited in claim 14, wherein said electro-mechanical actuating means further comprises:
a vertically-oriented shaft having a plurality of serrated teeth along its length;
a gear mechanism configured for cooperating with the serrated teeth to effect vertical movement of said shaft; and
an electric motor for driving said gear mechanism;
said shaft positioned over said cartridge in said actuation position for selective actuation of said cartridge between said open and closed positions via said vertical shaft movement.

16. A scent-delivery system as recited in claim 8, further comprising electronic means for providing said sliding movement of said cartridge supporting tray.

17. A scent-delivery system as recited in claim 16, wherein said electronic means for providing said sliding movement further comprises an electrically driven pinion attached to an interior surface of said housing and positioned for cooperating with a rack provided along at least one side of said tray.

18. A scent-delivery system as recited in claim 3, wherein said electronic controlling means further comprises a printed circuit board/micro-processor.
